(19) United States
(12) Patent Application Publication
(10) Pub. No.: US 2005/0109191 A1
(43) Pub. Date: May 26, 2005

(54) Musical shaker assembly for mounting on a drum beater foot pedal mechanism

(76) Inventor: Mark Gusek, Anaheim, CA (US)

Correspondence Address: RICHARD E. BEE, P.O. BOX 10544, COSTA MESA, CA, 92627, US

(21) Appl. No.: 10/717,876

(22) Filed: Nov. 20, 2003

(51) Int. Cl. G10D 13/02

(52) U.S. Cl. 84/422.1

(57) ABSTRACT

A musical shaker assembly for mounting on a drum beater foot pedal mechanism is described. The shaker assembly includes a container having located therein a plurality of hard pellets which are free to move about within the container. The shaker assembly further includes an elongated shaft having a first end portion attached to the container with the remainder of the shaft extending outward from the container. The outward end portion of the shaft is shaped to fit into a stem holder of a drum beater foot pedal mechanism.

### DESCRIPTION

1. Background of the Invention

This invention relates to a musical shaker assembly for mounting on a drum beater foot pedal mechanism. The foot pedal mechanism is, preferably, a commercially-available on-the-market drum beater foot pedal mechanism of the type used for bass drums.

Representative bass drum foot pedal mechanisms are described in U.S. Pat. No. 4,346,638 granted to Masao Hoshino on Aug. 31, 1982, U.S. Pat. No. 4,691,613 granted to Luke Jacobson on Sep. 8, 1987, U.S. Pat. No. 5,427,010 granted to Yoshiki Hoshino on Jun. 27, 1995 and U.S. Pat. No. 5,574,237 granted to Mitsuo Yanagisawa on Nov. 12, 1996.

An advantage of foot pedal mechanisms is that it frees up the musician's hands for other musical activities. A variety of foot pedal operated musical devices have been heretofore proposed. U.S. Pat. No. 2,475,542 granted to George Boykins on Jul. 5, 1949, U.S. Pat. No. 2,658,421 granted to Everett Clayton on Nov. 10, 1953, and U.S. Pat. No. 2,785,596 granted to Charles Korosh on Mar. 19, 1957 describe foot pedal mechanisms for rattling a pair of maracas. U.S. Pat. No. 3,994,197 granted to John Bills on Nov. 30, 1976 describes a foot pedal mechanism for shaking a tambourine. U.S. patent application publication U.S. 2001/0047715 published for Steven Rice on Dec. 6, 2001 describes a foot pedal operated mechanism for imparting an up and down motion to a rattling device. While these structures are interesting, they don't suggest applicant's novel solution for the case of musical shaker instruments.

### SUMMARY OF THE INVENTION

The present invention provides a musical shaker assembly for mounting on a drum beater foot pedal mechanism. The shaker assembly includes a container having located therein a plurality of hard pellets which are free to move about within the container. The shaker assembly further includes an elongated shaft having a first end portion attached to the container with the remainder of the shaft extending outward from the container. The outward end portion of the shaft is shaped to fit into a stem holder of a drum beater foot pedal mechanism.

For a better understanding of the present invention, together with other and further advantages and features thereof, reference is made to the following description taken in connection with the accompanying drawings, the scope of the invention being pointed out in the appended claims.

### BRIEF DESCRIPTION OF THE DRAWINGS

Referring to the drawings:

FIG. 1 is a side elevational view of a musical shaker assembly mounted on a drum beater foot pedal mechanism, the musical shaker assembly being constructed in accordance with the present invention;

FIG. 2 is an enlarged front elevational view of the shaker assembly of FIG. 1; and

FIG. 3 is an enlarged cross-sectional view taken along section line 3-3 of FIG. 2.

### DETAILED DESCRIPTION OF THE ILLUSTRATED EMBODIMENT

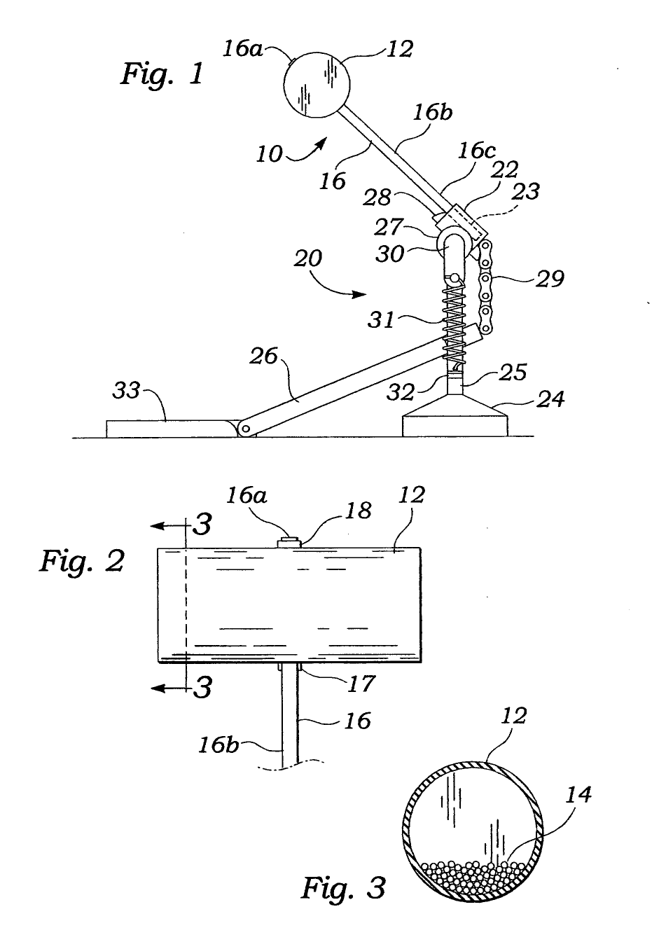

Referring to the FIG. 1 of the drawings, there is shown a musical shaker assembly 10 mounted on a drum beater foot pedal mechanism 20. The shaker assembly 10 includes a closed container 12 having located therein a plurality of loose hard pellets which are free to move about within the container 12. As shown in the cross-sectional view of FIG. 3, these hard pellets are identified by reference numeral 14. There are many of these pellets 14 and they may take the form of, for example, metal fragments, metal BB's, pieces of metal buckshot, sand, plant seeds, uncooked rice grains, rock fragments or rock pebbles. In some cases, the hard pellets 14 may be a mixture of two or more different kinds of pellets. For example, pellets 14 may be a mixture of at least two items from a group consisting of metal fragments, metal BB's, metal buckshot, sand, plant seeds, uncooked rice grains, rock fragments, and rock pebbles.

Container 12 may be, for example, a metal container or a hard plastic container or a hard wood container or a hard woven enclosed container. In the illustrated embodiment, container 12 is a closed metal can of elongated cylindrical shape. The shape, however, need not be cylindrical. Container 12 could be, for example, more of a football shape. The primary factor is that container 12 be of a size and shape which can conveniently be held in the hand of a musician for purposes of shaking same. A cylindrical metal can provides a structure which serves the purpose and is relatively inexpensive to fabricate.

The shaker assembly 10 further includes an elongated shaft 16 having a first end portion 16a attached to the container 12 with the remainder 16b of the shaft 16 extending outward from the container 12. The outward end portion 16c of shaft 16 is shaped to fit into a stem holder 22 of the drum beater foot pedal mechanism 20. More particularly, stem holder 22 has an internal passageway or borehole 23 which extends downward into the stem holder 22 for receiving and holding the shaft or stem of a drum beater. Typically, this internal passageway 23 will have a circular cross-section, in which case the end portion 16c of shaft 16 will be of cylindrical shape.

In the illustrated embodiment, the elongated shaft 16 is a cylindrical metal rod. It may be attached to the container 12, for example, by force-fitting the shaft 16 through the body of the container 12 in a central location on the container 12. This may be accomplished, for example, by forming holes in opposing curved sides of the container 12 in a central location on the container 12 and forcing shaft 16 through these holes so that the first end 16a of shaft 16 protrudes from one of these holes and the remainder 16b of shaft 16 extends outward from the other of these holes.

If desired, means may be provided for securing the container 12 in place on the shaft 16. This means for securing may include, for example, at least one raised shoulder portion 17 formed on the shaft 16 at the exit location of the remainder 16b of the shaft 16 from the container 12. This means for securing may further include, for example, a nut member 18 threaded onto the protruding first end 16a of the shaft 16. Tightening of nut member 18 pulls shaft 16 upward and causes the raised shoulder portions 17 to firmly engage the lower side of container 12. This locks container 12 firmly in place on shaft 16.

The foot pedal mechanism 20 depicted in FIG. 1 represents a commercially-available on-the-market drum beater foot pedal mechanism of the type used for beating bass drums. It includes a frame structure 24 having two vertically-extending support posts 25 individually located on opposite sides of a foot pedal 26. Only the nearer support post 25 is visible in FIG. 1, the other support post being located directly in line with it on the far side of foot pedal 26. Each vertical support post 25 has an enlarged head portion 27. A horizontal crossbar (not visible) is rotatably supported within these enlarged head portions 27. The stem holder 22 is mounted on this crossbar approximately midway between the two sides of foot pedal 26. A cam member 28 is affixed to the far side of stem holder 22. A pull chain 29 is mounted on cam member 28 and extends downward and is attached to the upper end of foot pedal 26. A crank arm 30 is attached to the end of the horizontal crossbar outward of the vertical support post 25. A return spring 31 is connected between the free end of crank arm 30 and a connector stub 32 on the side of vertical support post 25. The lower end of foot pedal 26 is hinged to a heel plate 33.

Depressing the foot pedal 26 pulls the pull chain 29 downward and causes a clockwise rotation of the horizontal crossbar on which is mounted the stem holder 22. This rotates stem holder 22 in a clockwise direction and moves the shaker container 12 to the right. This also rotates the lower end of crank arm 30 to the left to stretch out the return spring 31. Releasing or letting up on foot pedal 26 enables return spring 31 to pull the crank arm 30 back to its original position. This rotates the horizontal crossbar and attached stem holder 22 back to the original position shown in FIG. 1. This moves shaker container 12 to the left and back to its original position.

Successive depressing and letting up on foot pedal 26 causes a back and forth movement of the shaker container 12. This causes pellets 14 to move back and forth inside container 12 and successively strike opposing inner walls of container 12. This produces the desired rattling sound. The tone of this sound is determined by the material from which container 12 is made and by the particular material used for pellets 14.

An important advantage of the present invention is that it uses a commercially-available on-the-market foot pedal mechanism. No special or unique structure is needed. Also, the elongated shaft 16 may be the same metal shaft or drum head rod that is used for existing bass drum beaters. Thus, a foot-operated musical shaker can be provided with a minimum of effort and expense.

While there have been described what are at present considered to be preferred embodiments of this invention, it will be obvious to those skilled in the art that various changes and modifications may be made therein without departing from the invention and it is, therefore, intended to cover all such changes and modifications as come within the true spirit and scope of the invention.

1. A musical shaker assembly for mounting on a drum beater foot pedal mechanism, such shaker assembly comprising:
a container having located therein a plurality of hard pellets which are free to move about within the container;
and an elongated shaft having a first end portion attached to the container with the remainder of the shaft extending outward from the container, the outward end portion of the shaft being shaped to fit into a stem holder of a drum beater foot pedal mechanism.

2. A musical shaker assembly in accordance with claim 1 wherein the container is a metal container.

3. A musical shaker assembly in accordance with claim 1 wherein the container is a hard plastic container.

4. A musical shaker assembly in accordance with claim 1 wherein the container is a hard wood container.

5. A musical shaker assembly in accordance with claim 1 wherein the container is a closed metal can.

6. A musical shaker assembly in accordance with claim 1 wherein the plurality of hard pellets is comprised of many hard pellets.

7. A musical shaker assembly in accordance with claim 1 wherein the hard pellets are small pieces of metal.

8. A musical shaker assembly in accordance with claim 1 wherein the hard pellets are metal BB's.

9. A musical shaker assembly in accordance with claim 1 wherein the hard pellets are pieces of metal buckshot.

10. A musical shaker assembly in accordance with claim 1 wherein the elongated shaft is a cylindrical metal rod.

11. A musical shaker assembly in accordance with claim 1 wherein the elongated shaft is force-fit through the body of the container in a central location on the container.

12. A musical shaker assembly in accordance with claim 1 wherein the elongated shaft is attached by forming holes in opposing sides of the container in a central location on the container and forcing the shaft through these holes so that the first end of the shaft protrudes from one of these holes and the remainder of the shaft extends outward from the other of these holes.

13. A musical shaker assembly in accordance with claim 12 and including means for securing the container in place on the shaft.

14. A musical shaker assembly in accordance with claim 13 wherein the securing means includes at least one raised shoulder formed on the shaft at the exit location of the remainder of the shaft and a nut member threaded onto the protruding first end of the shaft.

15. A musical shaker assembly in accordance with claim 1 wherein the drum beater foot pedal mechanism is a commercially-available on-the-market bass drum beater foot pedal mechanism.

16. A musical shaker assembly in accordance with claim 1 wherein the hard pellets are one of the items in a group consisting of sand, plant seeds, uncooked rice grains, rock fragments and rock pebbles.

17. A musical shaker assembly in accordance with claim 1 wherein the hard pellets are a mixture of at least two different kinds of pellets.

18. A musical shaker assembly in accordance with claim 1 wherein the hard pellets are a mixture of at least two items from a group consisting of metal fragments, metal BB's, metal buckshot, sand, plant seeds, uncooked rice grains, rock fragments and rock pebbles.
